(19) United States
(12) Patent Application Publication
(10) Pub. No.: US 2007/0186097 A1
(43) Pub. Date: Aug. 9, 2007

(54) Sending of public keys by mobile terminals

(76) Inventors: David Arditti, Clamart (FR); Bruno Labbe, Plaisir (FR); Didier Begay, Champniers (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/588,949

(22) PCT Filed: Feb. 11, 2005
(86) PCT No.: PCT/FR05/00328

§ 371 Date: Aug. 8, 2006

(30) Foreign Application Priority Data
Feb. 11, 2004 (FR) 0401347

(51) Int. Cl. H04L 9/32; H04L 9/00; G06F 15/16; G06F 17/30; G06F 7/04; G06F 7/58; G06K 19/00; G06K 9/00

(52) U.S. Cl. 713/156; 713/173; 713/175; 726/3

(57) ABSTRACT

A certification method using a public key certification authority (30) and involving at least one mobile terminal (10) able to receive messages encrypted by that public key. The mobile terminal (10) generates the public key, and a telecommunications network entity (20) acquires said key from the mobile terminal (10) by means of a network call. The network entity authenticates the mobile terminal (10) by a party authentication process used in relation to a standard telephone call. The certification authority (30) is supplied with the public key and the associated result of the authentication process.

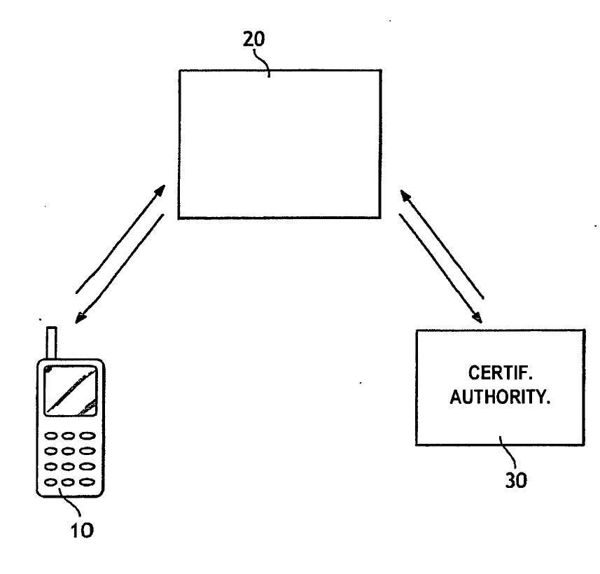

The invention relates to a public key infrastructure used in a mobile telephone network.

The invention also relates to mobile electronic data processing terminals possessing in particular a SIM or WIM card.

Such terminals can therefore be mobile telephones or WAP telephones.

They have in common the feature of possessing a SIM or WIM card and thus of being already identified on a network in relation to the operator providing the user's mobile telephone service.

To be more specific, the invention relates in particular to a public key infrastructure used in a mobile network.

A universal and recurrent question in the field of networks is how to establish by remote means mutual trust between parties who do not know each other. The solution exists, and consists in using a public key infrastructure (PKI).

A public key infrastructure has the advantage of enabling parties using it to rely on a high-security layer providing strong authentication, signing, and encryption. However, it has the drawback that organizing it remains complex, lengthy, difficult, and therefore costly for an operator.

At present, interactions between a certification authority and entities identified by certificates account for a major portion of certificate management, i.e. of approval operations essentially involving a public key. These interactions include operations such as registration for certification, certificate renewal, certificate revocation, backing up and recovering keys. In general, a certification authority (CA) must be able to authenticate the identities of the requesting entities before responding to requests. Moreover, requests need to be approved by authorized administrators or managers before they are serviced.

The means used by certification authorities to verify an identity before delivering a certificate may vary greatly. This variation depends in particular on the organization and the use of the certificate.

To achieve more flexibility, interaction with users may be separate from other functions of the certification authority and managed by a separate service known as the registration authority (RA).

An RA acts as an interface to the CA in that it receives requests from users, authenticates them, and forwards them to the CA. After receiving a response from the CA, the RA notifies the user of the result. The RA can be useful on a PKI scale across different administrative regions, different geographical areas, and other entities that differ in terms of policy and authentication requests.

The drawbacks of this infrastructure should be noted: it is long and costly to implement, it offers little flexibility in the generation of certificates (for reasons linked to certification policy), it represents a high cost to users seeking to obtain a certificate, and it imposes a considerable management workload on the certification operator.

In other words, a public key infrastructure offers high security but has the drawback of requiring prior registration with a registration authority.

The invention aims to facilitate the public key certification process.

That aim is achieved according to the invention by a certification method using a public key certification authority and involving at least one mobile terminal able to receive messages encrypted by that public key, the method being characterized in that it includes the step of the mobile terminal generating the public key, the step of a telecommunications network entity acquiring said key from the terminal by means of a network call, the step of the network entity authenticating the terminal by a party authentication process used in relation to a standard telephone call, and the step of supplying the certification authority with the public key and the associated result of the authentication process.

For example, a method of the above kind in particular enables a mobile network subscriber to generate a key pair before a certificate is issued by the operator.

The invention also provides a mobile telecommunications system comprising at least one mobile terminal and one network entity, characterized in that it includes means in the mobile terminal for generating a public key, means in the telecommunications network entity for acquiring said public key from the terminal by means of a network call, and means for authenticating the terminal by means of an authentication process used in relation to a standard telephone call, the system further including a certification authority and means for supplying the certification authority with the public key generated by the mobile terminal and the associated result of the authentication process.

There is further provided a mobile telecommunications terminal characterized in that it includes means for producing at least one key for decrypting messages received by the terminal and means for sending said key to a certification authority by means of a network call via a telephone network entity so that said key becomes a public key.

Other characteristics, objects, and advantages of the invention become apparent on reading the following detailed description, which is given with reference to the appended single figure, which represents a certification infrastructure conforming to a preferred embodiment of the invention.

The idea is to generate the key pair (public key+private key) in the user's mobile and then to forward the public key to a certification authority via a secure channel of the mobile telephone network.

This solution decentralizes the process and transfers the task of issuing the key pair to the mobile. It simplifies the certificate issuing/authentication stage and is of zero cost to the user. For the operator, the elements constituting the infrastructure are simplified.

This solution also makes it possible to carry out the registration stage at a different time (it can easily be carried out at the time of subscribing to the mobile telephone service).

It therefore offers the advantage of virtually eliminating the registration stage.

Elements specific to the current administration of keys and certificates are entered first. The means enabling use in a network environment of public keys and certificates with standardized formats are generally called a public key infrastructure.

PKI administration is a complex subject (management of keys, management of certificates, revocation lists, recovery, etc.).

The certificate issuing process depends on the certification authority issuing the certificates and how the certificates are used. A certificate must be issued in accordance with a clearly defined procedure if the certificate is to be of value in a “face to face” situation, for example when examining identity papers.

Different trusted authorities have different certificate-issuing policies.

In certain cases, an electronic address is sufficient on its own.

In other cases, a UNIX or Windows login and a password are sufficient.

However, for certificates granting major prerogatives, the issuing process may require notarized documents to be provided beforehand or complete “face to face” verification of identity.

Depending on the organization policy, the process of issuing certificates may take a form that is completely transparent for the user (which is to the detriment of security) or require the significant participation of the user and complex procedures.

Certificate-issuing methods must generally be very flexible so that different organizations can adapt them to their particular requirements.

Before a certificate is issued, the public key that it contains must be generated in corresponding relationship to a private key that is confidential.

It may sometimes be beneficial to issue a person one certificate for signing purposes and another certificate for encryption purposes.

To ensure high security, the private signature or encryption keys are held on a physical medium (smart card, dongle, USB, etc.) that is retained by the person that it represents.

With the objective of recovery, the private encryption key is held on a protected central server from which it may be retrieved, for example if a user loses a key.

An encryption key specifically dedicated to telephone calls is generally produced either locally (in a workstation or even in a smart card) or centrally (for example in a smart card personalization unit).

For example, local generation of keys maximizes non-repudiation but implies more participation by the user in the issuing process. Flexibility in managing keys is essential for most organizations, not forgetting the security aspect.

Like an identity card, a certificate has a period of validity. Any attempt to use a certificate before or after its period of validity will fail.

Thus mechanisms for administering and renewing certificates are essential for a security policy.

An administrator may wish to be advised when a certificate expires, and an appropriate renewal process may be therefore instituted to avoid any disagreement as to the use of certificates that have just expired. The certificate renewal process may involve using the same public key/private key pair again or issuing another pair.

A certificate may be suspended even if it is still valid, for example in the event of theft.

Similarly, it is sometimes necessary to revoke a certificate before its expiry date, for example if an employee leaves a company or is robbed of the medium storing a key pair.

Certificate revocation consists in publishing a certificate revocation list (CRL) in a directory at regular intervals. Verification against that list is then an integral part of the authentication process.

There follows a description of the elements that are usually employed in a telecommunications network to identify a party and to assure the security of a call, some of which elements described below are used in the present embodiment of the invention.

A mobile network infrastructure is designed to guarantee high security. Thus the GSM uses authentication and encryption processes. To guarantee this high security, the network uses strong mobile authentication.

The GSM uses four types of identity linked to the user:

the IMSI is known only within the GSM network;

the TMSI is a temporary identity used to identify the mobile during mobile/network interactions;

the MSISDN is the user's telephone number, which is the only identifier known to the outside world;

the MSRN, which is a number assigned on setting up a call.

Having outlined the common features of telephone communications networks, a few acronyms are defined next.

SIM: subscriber identity module.

IMSI: international mobile station identity, a unique identifier of the user (comprising 15 digits) stored in the SIM card.

TMSI: temporary mobile subscriber identity, an identity specific to a VLR, temporarily identifying the user in the VLR.

MSISDN: mobile station international ISDN number, an identity of the user that is visible in the telephone domain (e.g. 33 6 98 76 54 32).

IMEI: international mobile equipment identity, i.e. the identity of the terminal.

MSRN: mobile station roaming number, the identity necessary for routing calls between the gateway MSC to the PSTN and the current MSC of the mobile.

To prevent any use of a mobile account by a person other than the user 10, the GSM uses an authentication process aiming to protect both the user and the operator.

When a user 10 is seeking to be authenticated on the network, the network sends the mobile a random number RAND via a communications entity 20. The SIM card calculates the RAND signature using the A3 algorithm and the private key Ki stored in the SIM card.

The result SRES is then sent to the network.

To be sure of the identity of this user, the network (the entity 20) does the same thing, i.e. calculates a RAND signature using the algorithm A3 and the key Ki specific to each user stored in a database.

If the result calculated locally is identical to the result received, the user is authenticated; if not, the mobile is rejected.

To provide this confidentiality, an encryption key Kc is generated. This key is constructed using the random data transmitted by the network and a private key Ki specific to the user 10 and stored in the SIM card.

With these two parameters a key Kc is generated by the A8 algorithm. The network (the entity 20) performs the same operation.

The key Ki corresponding to the user previously identified is in an AUC (authentication centre) base and the network uses this key Ki to obtain the same encryption key Kc itself.

The idea is to define a simplified PKI model, with the following objectives: reducing management costs for the operator, i.e. avoiding a costly and centralized architecture, and relying on the security of the telephony architecture and in particular on the identification/authentication procedures on which the system relies.

Note that this solution can be applied to secure communication, for example to preserve the confidentiality of communication in a working environment or in the context of peer-to-peer communication.

As indicated above, the authentication procedure has high-security elements. Once this stage (authentication/confidentiality) has been completed, the idea is to generate a key pair in the telephone.

Afterwards, the user 10 sends the public key to a certification operator (here the entity 20 itself). The certification operator role is therefore performed at least in part by the mobile telephone operator itself.

Accordingly, authentication on the GSM network is strong authentication (involving possession of a security element and a secret).

Sending to the certification server 30 is effected in a secure tunnel.

In other words, after receiving the public key the operator 20 can certify the key received because it is certain of the identity corresponding to the public key presented: no identity theft is possible on the GSM network. The operator 20 then returns the certificate to its proprietor (if the entity 20 and the certification authority are one and the same) and/or deposits it in the public certification server 30.

The advantages of this solution are enormous, in particular the simplified certification procedure, the absence of any recovery process, and decentralized management transferred to the client.

The idea is therefore to generate the key pair in the mobile 10 so that the distinguished name (DN) for each certificate holder is the holder's telephone number and each certificate holder generates the corresponding key pair and obtains a certificate by sending the key pair for certification in the conventional way. The server determines the origin of the call automatically using the DN.

The sender (the user 10) is authenticated by the telephone network (the entity 20). The certification entity 30 that generates the certificate in corresponding relationship to the received key is certain of the identity certified in the certificate thanks to the identification by the telephone entity 20 and its standard mobile terminal identification means.

The server 30 can therefore finally generate the certificate corresponding to the public key received and send the certificate to its proprietor.

The method described is executed by a computer program.

That computer program is designed to be stored in and/or transmitted by a data medium and includes software instructions for having the method executed by an electronic data processing device, in this instance the measuring device described.

1. A certification method using a public key certification authority (30) and involving at least one mobile terminal (10) able to receive messages encrypted by that public key, wherein the method comprises:
the step of the mobile terminal (10) generating the public key;
the step of a telecommunications network entity (20) acquiring said key from the terminal (10) by means of a network call;
the step of the network entity authenticating the terminal (10) by a party authentication process used in relation to a standard telephone call; and
the step of supplying the certification authority (30) with the public key and the associated result of the authentication process.

2. A method according to claim 1, wherein the step of authenticating the mobile terminal (10) includes the mobile terminal (10) sending a calculation result involving a confidential key stored in the mobile terminal and the step of the network entity (20) comparing the result with an expected result also calculated by the network entity (20) using the same confidential key, a positive comparison result being interpreted as an identification of the mobile terminal.

3. A method according to claim 2, comprising the step of the network entity sending random data to the terminal and the step of the terminal calculating the random data sent by the network entity, the step of calculation by the network entity also involving said random data with a view to said comparison of results.

4. A method according to claim 1, further comprising the step of the mobile terminal (10) generating, in addition to the public key, a confidential key held in memory in the mobile terminal (10) and used to decrypt received messages that were encrypted with the public key.

5. A method according to claim 4, wherein the terminal is adapted to send messages and to append to them an authentication signature produced using the confidential key that it previously generated itself.

6. A method according to claim 1, further comprising the step of the network entity (20) sending the public key to the certification authority (30) via a channel that is secured against unauthorized reading.

7. A method according to claim 1, further comprising the step of the mobile terminal (10) using an authentication key of the mobile terminal (10) usually employed in relation to telephone calls, generating an encryption key, encrypting messages using that encryption key and sending said messages.

8. A mobile telecommunications system comprising
at least one mobile terminal (10); and
one network entity (20);
means in the mobile terminal (10) for generating a public key);
means in the telecommunications network entity (20) for acquiring said public key from the mobile terminal (10) by means of a network call;
means for authenticating the mobile terminal by means of an authentication process used in relation to a standard telephone call;
a certification authority; and
means for supplying the certification authority with the public key generated by the mobile terminal and the associated result of the authentication process.

9. A mobile telecommunications terminal (10), comprising:
means for producing at least one key for decrypting messages received by the terminal; and
means for sending said key to a certification authority (30) by means of a network call via a telephone network entity (20) so that said key becomes a public key.
